(19) United States
(12) Patent Application Publication
(10) Pub. No.: US 2020/0184722 A1
(43) Pub. Date: Jun. 11, 2020

(54) PERIPHERY MONITORING DEVICE

(71) Applicant: AISIN SEIKI KABUSHIKI KAISHA, Kariya-shi, Aichi-ken (JP)

(72) Inventor: Kazuya WATANABE, Anjo-shi (JP)

(73) Assignee: AISIN SEIKI KABUSHIKI KAISHA, Kariya-shi, Aichi-ken (JP)

(21) Appl. No.: 16/630,753

(22) PCT Filed: Mar. 5, 2018
(86) PCT No.: PCT/JP2018/008407

§ 371 Date: Jan. 13, 2020

(30) Foreign Application Priority Data
Aug. 14, 2017 (JP) 2017-156640

(51) Int. Cl. G06T 19/00; B60R 1/00; H04N 7/18

(52) U.S. Cl. CPC G06T 19/00; B60R 1/002; B60R 2300/802; B60R 2300/10; B60R 2300/20; H04N 7/181

(57) ABSTRACT

A periphery monitoring device according to an embodiment includes, as an example, a processor that generates a display image obtained by viewing, from a virtual viewpoint, a point of gaze in a virtual space including a model obtained by pasting a captured image obtained by imaging a surrounding area of a vehicle using an imaging unit provided on the vehicle to a three-dimensional plane around the vehicle, and including a three-dimensional vehicle image; outputs the display image to a display. The processor moves the point of gaze in conjunction with a movement of the virtual viewpoint in a vehicle width direction of the vehicle image when an instruction is made through an operation input unit to move the virtual viewpoint in the vehicle width direction of the vehicle image.

### TECHNICAL FIELD

Embodiments of the present invention relate to a periphery monitoring device.

### BACKGROUND ART

Techniques have been developed in which a display image that is a three-dimensional image around a vehicle and is obtained by viewing a point of gaze around the vehicle from a virtual viewpoint is generated based on a captured image obtained by imaging an area around the vehicle using an imaging unit, and the generated display image is displayed on a display.

### CITATION LIST

### Patent Literature

Patent Document 1: International Publication No. 2014/156220

### SUMMARY OF INVENTION

### Problem to be Solved by the Invention

However, if a user sets both the point of gaze and the virtual viewpoint when displaying the display image on the display, a large burden is imposed on the user to set the point of gaze and the virtual viewpoint.

### Means for Solving Problem

A periphery monitoring device of an embodiment includes, for example: a generator configured to generate a display image obtained by viewing, from a virtual viewpoint, a point of gaze in a virtual space including a model obtained by pasting a captured image obtained by imaging a surrounding area of a vehicle using an imaging unit provided on the vehicle to a three-dimensional plane around the vehicle, and including a three-dimensional vehicle image; and an output unit configured to output the display image to a display, wherein the generator is configured to move the point of gaze in conjunction with a movement of the virtual viewpoint in a vehicle width direction of the vehicle image when an instruction is made through an operation input unit to move the virtual viewpoint in the vehicle width direction of the vehicle image. Accordingly, as an example, the periphery monitoring device according to the present embodiment can display the display image facilitating recognition of a positional relation between the vehicle and an obstacle without increasing a burden of the user for setting the point of gaze.

In the periphery monitoring device of the embodiments, wherein the generator is configured to move the point of gaze in the vehicle width direction. Accordingly, as an example, the periphery monitoring device according to the present embodiment can display the display image further facilitating the recognition of the positional relation between the vehicle and the obstacle.

In the periphery monitoring device of the embodiments, wherein the generator is configured to move the point of gaze in the same direction as the direction of the movement of the virtual viewpoint in the vehicle width direction. Accordingly, as an example, the periphery monitoring device according to the present embodiment can generate an image desired to be checked by a passenger of the vehicle as the display image.

In the periphery monitoring device of the embodiments, wherein the generator is configured to match a position of the virtual viewpoint with a position of the point of gaze in the vehicle width direction. Accordingly, with the periphery monitoring device according to the present embodiment, as an example, the passenger of the vehicle can display the desired display image with a smaller number of operations when the passenger wants to avoid contact of the vehicle with the obstacle present on a lateral side of the vehicle.

In the periphery monitoring device of the embodiments, wherein an amount of movement of the point of gaze in the vehicle width direction is switchable to any one of a plurality of amounts of movement different from one another. Accordingly, as an example, the periphery monitoring device according to the present embodiment can display the display image further facilitating the recognition of the positional relation between the vehicle and the obstacle.

In the periphery monitoring device of the embodiments, wherein the amount of movement of the point of gaze in the vehicle width direction is switchable so as to be smaller than an amount of movement of the virtual viewpoint in the vehicle width direction. Accordingly, with the periphery monitoring device according to the present embodiment, as an example, the obstacle present near the vehicle does not deviate from a view angle of the display image, and the point of gaze can be moved to a position in which a position desired to be viewed by the passenger of the vehicle can be more easily checked.

In the periphery monitoring device of the embodiments, wherein the amount of movement of the point of gaze in the vehicle width direction is switchable so as to be larger than an amount of movement of the virtual viewpoint in the vehicle width direction. Accordingly, as an example, the periphery monitoring device according to the present embodiment can display the display image that further facilitates the recognition of the positional relation between the vehicle and the obstacle present in a wide range in a right-left direction of the vehicle.

In the periphery monitoring device of the embodiments, wherein a position of the point of gaze in a front-rear direction of the vehicle image is switchable to any one of a plurality of positions different from one another. Accordingly, as an example, the periphery monitoring device according to the present embodiment can display the display image further facilitating the recognition of the positional relation between the vehicle and the obstacle.

### BRIEF DESCRIPTION OF DRAWINGS

FIG. 1 is a perspective view illustrating an example of a state in which a part of a passenger compartment of a vehicle provided with a periphery monitoring device according to a first embodiment of the present invention is viewed through;

FIG. 2 is a plan view of an example of the vehicle according to the first embodiment;

FIG. 3 is a block diagram illustrating an example of a functional configuration of the vehicle according to the first embodiment;

FIG. 4 is a block diagram illustrating an example of a functional configuration of an electronic control unit (ECU) included in the vehicle according to the first embodiment;

FIG. 5 is a flowchart illustrating an example of a flow of displaying processing of a display image performed by the vehicle according to the first embodiment;

FIG. 6 is a diagram for explaining an example of a camera picture model used for generating the display image by the vehicle according to the first embodiment;

FIG. 7 is a diagram for explaining the example of the camera picture model used for generating the display image by the vehicle according to the first embodiment;

FIG. 8 is a diagram for explaining an example of the camera picture model and a vehicle image used for generating the display image in the vehicle according to the first embodiment;

FIG. 9 is a diagram for explaining another example of the camera picture model and the vehicle image used for generating the display image in the vehicle according to the first embodiment;

FIG. 10 is a diagram for explaining an example of movement processing of a point of gaze in the vehicle according to the first embodiment;

FIG. 11 is a diagram for explaining another example of the movement processing of the point of gaze in the vehicle according to the first embodiment;

FIG. 12 is a diagram illustrating an example of the display image when the point of gaze is not moved in conjunction with a movement of a virtual viewpoint;

FIG. 13 is a diagram illustrating an example of the display image generated in the vehicle according to the first embodiment;

FIG. 14 is a diagram illustrating another example of the display image generated in the vehicle according to the first embodiment;

FIG. 15 is a diagram illustrating still another example of the display image generated in the vehicle according to the first embodiment;

FIG. 16 is a diagram illustrating still another example of the display image generated in the vehicle according to the first embodiment; and

FIG. 17 is a diagram for explaining examples of the movement processing of the point of gaze in the vehicle according to a second embodiment of the present invention.

### DESCRIPTION OF EMBODIMENTS

Exemplary embodiments of the present invention will be disclosed below. Configurations of the embodiments described below, and operations, results, and effects brought about by the configurations are merely exemplary. The present invention can be achieved by any configuration other than the configurations disclosed in the following embodiments, and can attain at least one of various types of effects and secondary effects based on the basic configurations.

A vehicle provided with a periphery monitoring device (periphery monitoring system) according to the embodiments may be an automobile (internal combustion engined automobile) using an internal combustion engine (engine) as a driving source, an automobile (such as an electric vehicle or a fuel cell vehicle) using an electric motor (motor) as a driving source, or an automobile (hybrid vehicle) using both the engine and the motor as driving sources. The vehicle can be provided with any of various types of transmissions, and various types of devices (such as systems and components) required for driving the internal combustion engine and/or the electric motor. For example, systems, numbers, and layouts of devices for driving wheels on the vehicle can be variously set.

### First Embodiment

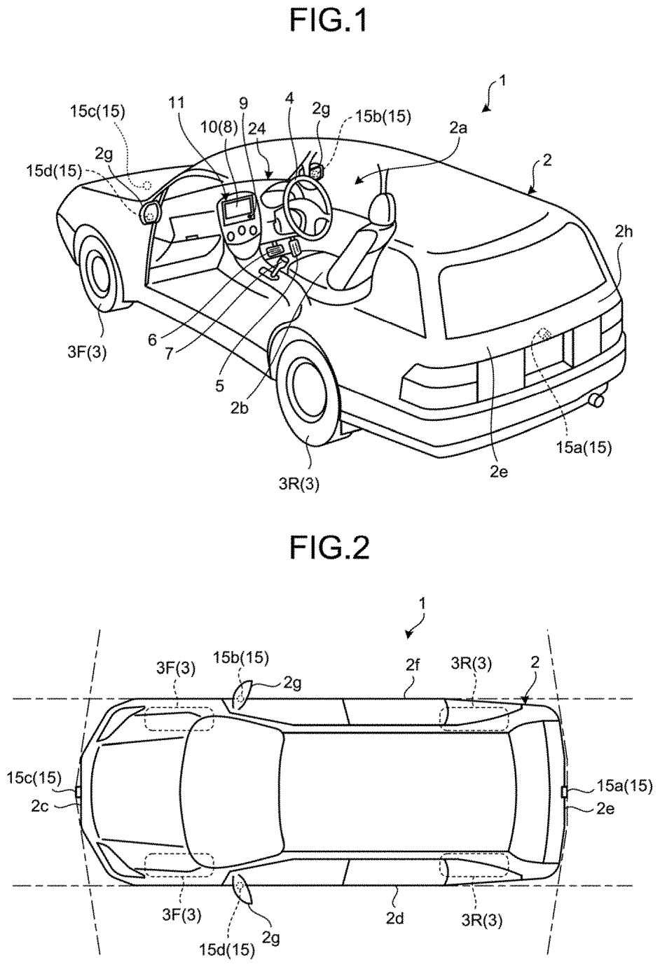

FIG. 1 is a perspective view illustrating an example of a state in which a part of a passenger compartment of the vehicle provided with the periphery monitoring device according to a first embodiment of the present invention is viewed through. As illustrated in FIG. 1, a vehicle 1 includes a vehicle body 2, a steering unit 4, an acceleration operation unit 5, a braking operation unit 6, a gear shift operation unit 7, and a monitor device 11. The vehicle body 2 includes a passenger compartment 2a in which a passenger rides. The passenger compartment 2a is provided therein with, for example, the steering unit 4, the acceleration operation unit 5, the braking operation unit 6, and the gear shift operation unit 7 in a state in which a driver as the passenger is seated in a seat 2b. The steering unit 4 is, for example, a steering wheel projecting from a dashboard 24. The acceleration operation unit 5 is, for example, an accelerator pedal located near a foot of the driver. The braking operation unit 6 is, for example, a brake pedal located near the foot of the driver. The gear shift operation unit 7 is, for example, a shift lever projecting from a center console.

The monitor device 11 is provided, for example, at a central part in a vehicle width direction (that is, a right-left direction) of the dashboard 24. The monitor device 11 may have a function of, for example, a navigation system or an audio system. The monitor device 11 includes a display 8, a voice output device 9, and an operation input unit 10. The monitor device 11 may include various types of operation input units, such as switches, dials, joysticks, and push-buttons.

The display 8 is constituted by, for example, a liquid crystal display (LCD) or an organic electroluminescent display (OELD), and can display various images based on image data. The voice output device 9 is constituted by, for example, a speaker, and outputs various voices based on voice data. The voice output device 9 may be provided in a different position in the passenger compartment 2a other than the monitor device 11.

The operation input unit 10 is constituted by, for example, a touchscreen panel, and allows the passenger to enter various types of information. The operation input unit 10 is provided on a display screen of the display 8, and allows the images displayed on the display 8 to be viewed through. With this configuration, the operation input unit 10 allows the passenger to view the images displayed on the display screen of the display 8. The operation input unit 10 detects a touch operation of the passenger on the display screen of the display 8 to receive an input of each of the various types of information by the passenger.

FIG. 2 is a plan view of an example of the vehicle according to the first embodiment. As illustrated in FIGS. 1 and 2, the vehicle 1 is, for example, a four-wheeled automobile, and includes two right and left front wheels 3F and two right and left rear wheels 3R. All or some of the four wheels 3 are steerable.

The vehicle 1 is provided with a plurality of imaging units 15. In the present embodiment, the vehicle 1 is provided with, for example, four imaging units 15a to 15d. The imaging units 15 are digital cameras each having an image pickup device, such as a charge-coupled device (CCD) or a complementary metal-oxide-semiconductor (CMOS) image sensor (CIS). The imaging units 15 can image a surrounding area of the vehicle 1 at a predetermined frame rate. The imaging units 15 output a captured image obtained by imaging the surrounding area of the vehicle 1. Each of the imaging units 15 includes a wide-angle lens or a fish-eye lens, and can image a range of, for example, 140 degrees to 220 degrees in the horizontal direction. An optical axis of the imaging unit 15 may be set obliquely downward.

Specifically, the imaging unit 15a is located, for example, at a rear end 2e of the vehicle body 2, and is provided at a wall below a rear window of a rear hatch door 2h. The imaging unit 15a can image an area behind the vehicle 1 out of the surrounding area of the vehicle 1. The imaging unit 15b is located, for example, at a right end 2f of the vehicle body 2, and is provided at a right door mirror 2g. The imaging unit 15b can image an area on a side of the vehicle out of the surrounding area of the vehicle 1. The imaging unit 15c is located, for example, on a front side of the vehicle body 2, that is, at a front end 2c in a front-rear direction of the vehicle 1, and is provided, for example, at a front bumper or a front grill. The imaging unit 15c can image an area in front of the vehicle 1 out of the surrounding area of the vehicle 1. The imaging unit 15d is located, for example, on a left side, that is, at a left end 2d in the vehicle width direction of the vehicle body 2, and is provided at a left door mirror 2g. The imaging unit 15d can image an area on a side of the vehicle 1 out of the surrounding area of the vehicle 1.

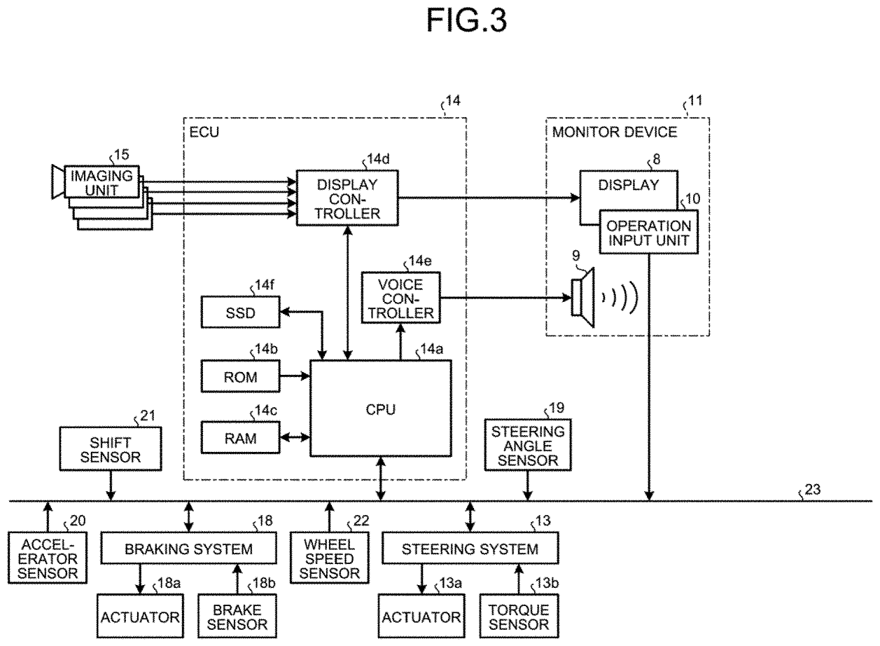

FIG. 3 is a block diagram illustrating an example of a functional configuration of the vehicle according to the first embodiment. As illustrated in FIG. 3, the vehicle 1 includes a steering system 13, a braking system 18, a steering angle sensor 19, an accelerator sensor 20, a shift sensor 21, wheel speed sensors 22, an in-vehicle network 23, and an electronic control unit (ECU) 14. The monitor device 11, the steering system 13, the braking system 18, the steering angle sensor 19, the accelerator sensor 20, the shift sensor 21, the wheel speed sensors 22, and the ECU 14 are electrically connected together through the in-vehicle network 23 serving as an electrical communication line. The in-vehicle network 23 is configured as, for example, a Controller Area Network (CAN).

The steering system 13 is, for example, an electric power steering system or a steer-by-wire (SBW) system. The steering system 13 includes an actuator 13a and a torque sensor 13b. The steering system 13 is electrically controlled by, for example, the ECU 14, and operates the actuator 13a to steer the wheels 3 by supplementing a steering force by adding torque to the steering unit 4. The torque sensor 13b detects torque applied to the steering unit 4 by the driver, and transmits the detection result to the ECU 14.

The braking system 18 includes an anti-lock braking system (ABS) that controls locking of brakes of the vehicle 1, an electronic stability control (ESC) that restrains sideslip of the vehicle 1 during cornering, an electric braking system that enhances braking forces to assist the brakes, and a brake-by-wire (BBW). The braking system 18 includes an actuator 18a and a brake sensor 18b. The braking system 18 is electrically controlled by, for example, the ECU 14, and applies the braking forces to the wheels 3 through the actuator 18a. The braking system 18 detects, for example, locking of a brake, free spin of any one of the wheels 3, or a sign of the sideslip based on, for example, a rotational difference between the right and left wheels 3, and performs control to restrain the locking of the brake, the free spin of the wheel 3, or the sideslip. The brake sensor 18b is a displacement sensor that detects a position of the brake pedal serving as a movable part of the braking operation unit 6, and transmits the detection result of the position of the brake pedal to the ECU 14.

The steering angle sensor 19 is a sensor that detects an amount of steering of the steering unit 4, such as the steering wheel. In the present embodiment, the steering angle sensor 19 that is constituted by, for example, a Hall element detects a rotational angle of a rotating part of the steering unit 4 as the amount of steering, and transmits the detection result to the ECU 14. The accelerator sensor 20 is a displacement sensor that detects a position of the accelerator pedal serving as a movable part of the acceleration operation unit 5, and transmits the detection result to the ECU 14.

The shift sensor 21 is a sensor that detects a position of a movable part (for example, a bar, an arm, or a button) of the gear shift operation unit 7, and transmits the detection result to the ECU 14. The wheel speed sensors 22 are sensors that each include, for example, a Hall element, and detect amounts of rotation of the wheels 3 or numbers of rotations of the wheels 3 per unit time, and transmit the detection results to the ECU 14.

The ECU 14 generates an image obtained by viewing a point of gaze in the surrounding area of the vehicle 1 from a virtual viewpoint based on the captured image obtained by imaging the surrounding area of the vehicle 1 using the imaging units 15, and displays the generated image on the display 8. The ECU 14 is constituted by, for example, a computer, and is in charge of overall control of the vehicle 1 through cooperation between hardware and software. Specifically, the ECU 14 includes a central processing unit (CPU) 14a, a read-only memory (ROM) 14b, a random access memory (RAM) 14c, a display controller 14d, a voice controller 14e, and a solid-state drive (SSD) 14f. The CPU 14a, the ROM 14b, and the RAM 14c may be provided on the same circuit board.

The CPU 14a reads a computer program stored in a nonvolatile storage device, such as the ROM 14b, and executes various types of arithmetic processing according to the computer program. The CPU 14a executes, for example, image processing on image data to be displayed on the display 8, and calculation of a distance to an obstacle present in the surrounding area of the vehicle 1.

The ROM 14b stores therein various computer programs and parameters required for executing the computer programs. The RAM 14c temporarily stores therein various types of data used in the arithmetic processing by the CPU 14a. The display controller 14d mainly executes, among the arithmetic processing operations in the ECU 14, for example, image processing on image data acquired from the imaging units 15 and to be output to the CPU 14a, and conversion of image data acquired from the CPU 14a into display image data to be displayed on the display 8. The voice controller 14e mainly executes, among the arithmetic processing operations in the ECU 14, processing of a voice acquired from the CPU 14a and to be output to the voice output device 9. The SSD 14f is a rewritable nonvolatile storage device, and keeps storing data acquired from the CPU 14a even after power supply to the ECU 14 is turned off.

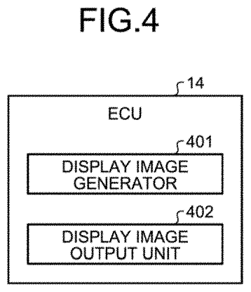

FIG. 4 is a block diagram illustrating an example of a functional configuration of the ECU included in the vehicle according to the first embodiment. As illustrated in FIG. 4, the ECU 14 includes a display image generator 401 and a display image output unit 402. For example, a processor, such as the CPU 14a mounted on the circuit board, executes a computer program for periphery monitoring stored in a storage medium, such as the ROM 14b or the SSD 14f, and thus, the ECU 14 performs functions of the display image generator 401 and the display image output unit 402. A part or the whole of the display image generator 401 and the display image output unit 402 may be configured as hardware, such as a circuit.

The display image generator 401 acquires, from the imaging units 15, the captured image obtained by imaging the surrounding area of the vehicle 1 using the imaging units 15. In the present embodiment, the display image generator 401 acquires the captured image obtained by imaging the surrounding area of the vehicle 1 in a position (hereinafter, called “past position”) of the vehicle 1 at a certain time (hereinafter, called “past time”) using the imaging units 15. Then, the display image generator 401 generates, based on the acquired captured image, the display image visualizing a positional relation between the vehicle 1 and the obstacle present in the surrounding area of the vehicle 1.

Specifically, based on the acquired captured image, the display image generator 401 generates, as the display image, the image obtained by viewing the point of gaze in a virtual space from the virtual viewpoint received through the operation input unit 10. The virtual space is a space around the vehicle 1, and is a space in which a vehicle image is provided in a position (for example, the current position) of the vehicle 1 at a time (for example, the current time) after the past time. The vehicle image is a three-dimensional image of the vehicle 1 allowing viewing therethrough the virtual space.

In the present embodiment, the display image generator 401 pastes the acquired captured image to a three-dimensional plane (hereinafter, called “camera picture model”) around the vehicle 1 to generate a space including the camera picture model as a space around the vehicle 1. Then, the display image generator 401 generates, as the virtual space, a space in which the vehicle image is disposed corresponding to the current position of the vehicle 1 in the generated space. Thereafter, the display image generator 401 generates, as the display image, an image obtained by viewing the point of gaze in the generated virtual space from the virtual viewpoint received through the operation input unit 10.

If an instruction is made through the operation input unit 10 to move the virtual viewpoint in the vehicle width direction of the vehicle image, the display image generator 401 moves the point of gaze in conjunction with the movement of the virtual viewpoint in the vehicle width direction of the vehicle image. Since this operation can move the point of gaze in conjunction with the movement of the virtual viewpoint, the display image facilitating recognition of the positional relation between the vehicle 1 and the obstacle can be displayed without increasing a burden of a user for setting the point of gaze. In the present embodiment, the display image generator 401 moves the point of gaze in the vehicle width direction in conjunction with the movement of the virtual viewpoint in the vehicle width direction of the vehicle image. Since this operation can move also the point of gaze in a direction toward a point desired to be viewed by the passenger of the vehicle 1 in conjunction with the movement of the virtual viewpoint, the display image further facilitating the recognition of the positional relation between the vehicle 1 and the obstacle can be displayed without increasing the burden of the user for setting the point of gaze. The display image output unit 402 outputs the display image generated by the display image generator 401 to the display 8.

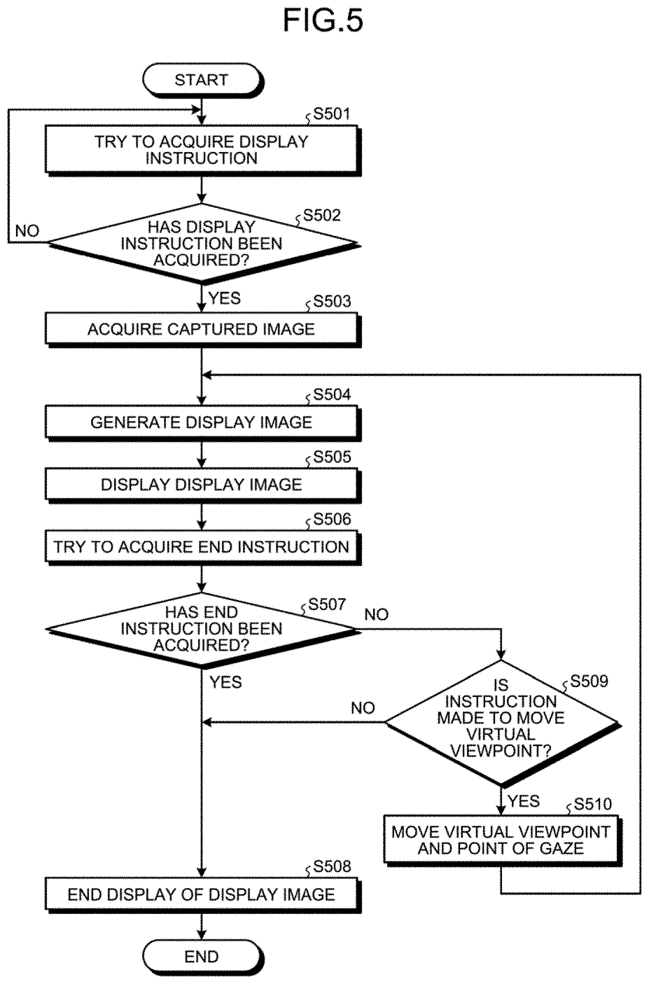

The following describes an example of a flow of displaying processing of the display image performed by the vehicle 1 according to the present embodiment, with reference to FIG. 5. FIG. 5 is a flowchart illustrating the example of the flow of the displaying processing of the display image performed by the vehicle according to the first embodiment.

In the present embodiment, the display image generator 401 tries to acquire a display instruction for instructing to display a display image (Step S501). If the display instruction has been acquired (Yes at Step S502), the display image generator 401 acquires a captured image obtained by imaging the surrounding area of the vehicle 1 in the past position using the imaging units 15 (Step S503). For example, the display image generator 401 acquires the captured image obtained by imaging the surrounding area of the vehicle 1 using the imaging units 15 in a past position of the vehicle 1 at a past time earlier by a preset time (for example, several seconds) than the current time (or in a past position before the current position of the vehicle 1 by a preset distance (for example, 2 m)).

Then, the display image generator 401 generates, based on the acquired captured image, the display image obtained by viewing the point of gaze in the virtual space from the virtual viewpoint received through the operation input unit 10 (Step S504). In the present embodiment, the display image generator 401 generates the display image based on the captured image obtained by imaging the surrounding area of the vehicle 1 in the past position using the imaging units 15. However, the display image only needs to be generated based on a captured image obtained by imaging the surrounding area of the vehicle 1 using the imaging units 15. For example, the display image generator 401 generates the display image based on the captured image obtained by imaging the surrounding area of the vehicle 1 in the current position using the imaging units 15.

The display image generator 401 may switch the captured image used for generating the display image between the captured image obtained by imaging the surrounding area of the vehicle 1 in the past position using the imaging units 15 and the captured image obtained by imaging the surrounding area of the vehicle 1 in the current position using the imaging units 15 according to a traveling condition of the vehicle 1. For example, if the shift sensor 21 detects that the vehicle 1 travels on an off-road surface based on, for example, a shift of the gear shift operation unit 7 to a low-speed gear position (such as L4), the display image generator 401 generates the display image based on the captured image obtained by imaging the surrounding area of the vehicle 1 in the past position using the imaging units 15. As a result, the display image can be generated that has a view angle at which a road surface condition in the periphery of the vehicle 1 can be easily recognized. If, in contrast, the shift sensor 21 detects that the vehicle 1 travels on an on-road surface based on, for example, a shift of the gear shift operation unit 7 to a high-speed gear position, the display image generator 401 generates the display image based on the captured image obtained by imaging the surrounding area of the vehicle 1 in the current position using the imaging units 15. As a result, the display image can be generated that has a view angle at which the latest positional relation between the vehicle 1 and the obstacle present in the surrounding area of the vehicle 1 can be easily recognized.

The display image output unit 402 outputs the display image generated by the display image generator 401 to the display 8 to display the display image on the display 8 (Step S505). Thereafter, the display image generator 401 tries to acquire an end instruction for ending the display of the display image (Step S506). If the end instruction has been acquired (Yes at Step S507), the display image output unit 402 stops outputting the display image to the display 8, and ends the display of the display image on the display 8 (Step S508).

If, instead, the end instruction has not been acquired (No at Step S507), the display image generator 401 determines whether the instruction is made through the operation input unit 10 to move the virtual viewpoint in the vehicle width direction of the vehicle image (Step S509). If a preset time has elapsed while no instruction is made to move the virtual viewpoint in the vehicle width direction of the vehicle image (No at Step S509), the display image output unit 402 stops outputting the display image to the display 8, and ends the display of the display image on the display 8 (Step S508).

If the instruction is made to move the virtual viewpoint in the vehicle width direction of the vehicle image (Yes at Step S509), the display image generator 401 moves the virtual viewpoint in the vehicle width direction of the vehicle image, and moves the point of gaze in the vehicle width direction of the vehicle image in conjunction with the movement of the virtual viewpoint (Step S510). Thereafter, the display image generator 401 performs the processing at Step S504 again to regenerate the display image obtained by viewing the point of gaze after being moved in the virtual space from the virtual viewpoint after being moved.

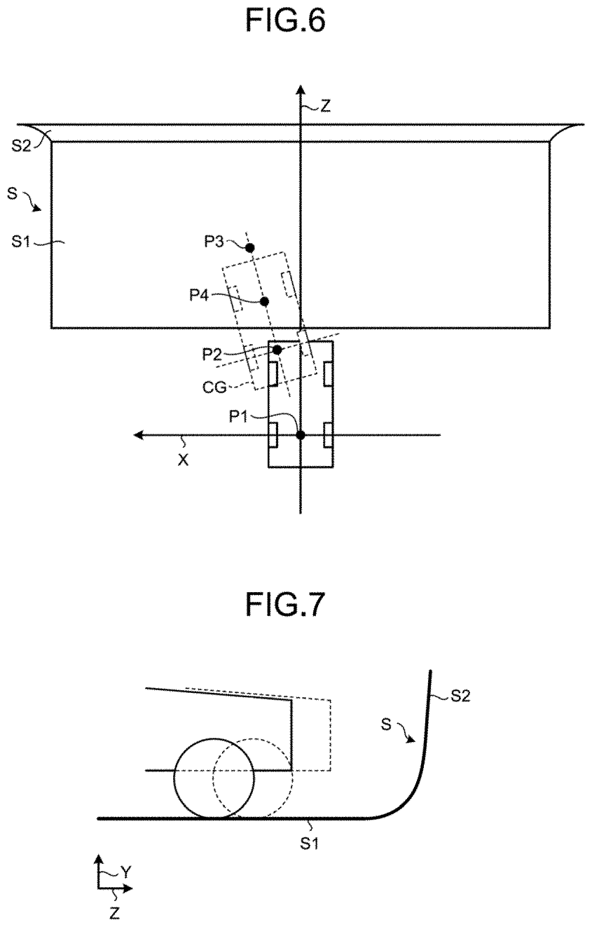

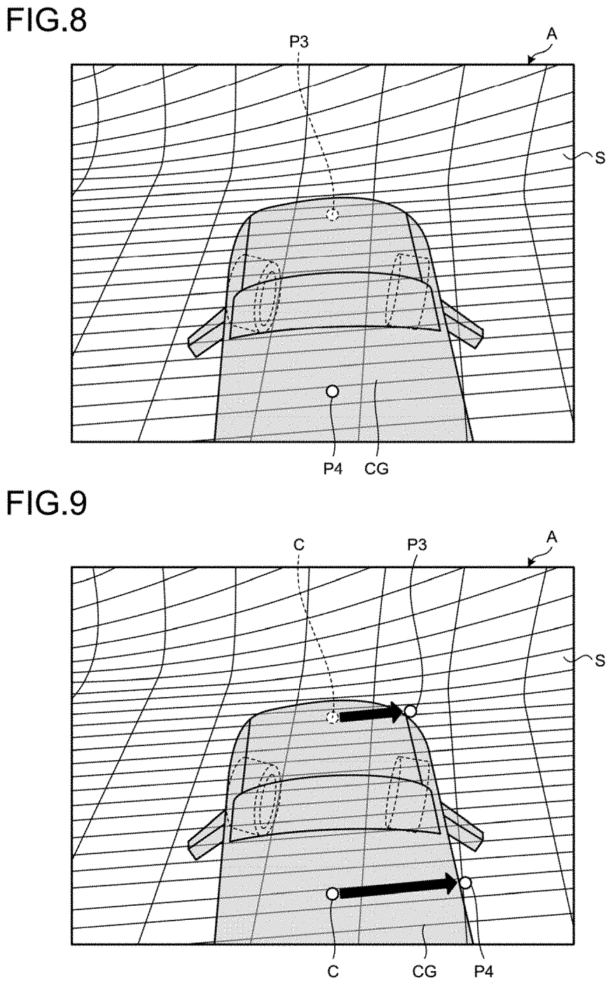

The following describes generation processing of the display image performed by the vehicle 1 according to the present embodiment, with reference to FIGS. 6 to 9. FIGS. 6 and 7 are diagrams for explaining an example of the camera picture model used for the generation of the display image by the vehicle according to the first embodiment. In FIGS. 6 and 7, a Z-direction denotes a direction parallel to a surface (ground surface) of contact of a tire of the vehicle 1; an X-direction denotes a direction parallel to the surface of contact of the tire of the vehicle 1 and orthogonal to the Z-direction; and a Y-direction denotes a direction orthogonal to the surface of contact. FIGS. 8 and 9 are each a diagram for explaining an example of the camera picture model and the vehicle image used for the generation of the display image in the vehicle according to the first embodiment.

In the present embodiment, as illustrated in FIGS. 6 and 7, the display image generator 401 generates in advance a camera picture model S including a first plane S1 and a second plane S2. In the present embodiment, the first plane S1 is a flat plane corresponding to the road surface on which the vehicle 1 is present. For example, the first plane S1 is a flat oval plane. The second plane S2 is a curved plane gradually rising from an outer side (outer edge) of the first plane S1 toward the Y-direction as being away from the first plane with respect to the first plane S1. The second plane S2 is, for example, a curved plane rising from the outer side of the first plane S1 toward the Y-direction in an elliptical shape or a parabolic shape. In other words, the display image generator 401 generates a bowl-shaped or cylindrical three-dimensional pasting plane as the camera picture model S.

In the present embodiment, the display image generator 401 generates the three-dimensional pasting plane including the flat first plane S1 and the curved second plane S2 as the camera picture model S. However, the display image generator 401 is not limited to this example as long as generating a three-dimensional pasting plane as the camera picture model S. For example, the display image generator 401 may generate, as the camera picture model S, a three-dimensional pasting plane including the flat first plane S1 and the flat-surfaced second plane S2 that rises from an outer side of the first plane S1 vertically or gradually with respect to the first plane S1.

Then, the display image generator 401 pastes the captured image obtained by imaging the surrounding area of the vehicle 1 using the imaging unit 15 in a past position P1 to the camera picture model S. In the present embodiment, the display image generator 401 creates in advance a coordinate table that associates coordinates (hereinafter, called “three-dimensional coordinates”) of points (hereinafter, called “pasting points”) in the camera picture model S represented in a world coordinate system having an origin in the past position P1 with coordinates (hereinafter, called “camera picture coordinates”) of points (hereinafter, called “camera picture points”) in the captured image to be pasted to the pasting points of the three-dimensional coordinates. Then, the display image generator 401 pastes the camera picture points in the captured image to the pasting points of the three-dimensional coordinates associated with the camera picture coordinates of the camera picture points in the coordinate table. In the present embodiment, the display image generator 401 creates the coordinate table each time the internal combustion engine or the electric motor of the vehicle 1 starts.

Then, the display image generator 401 disposes the camera picture model S with the captured image pasted thereto in the space around the vehicle 1. In addition, as illustrated in FIG. 8, the display image generator 401 generates, as a virtual space A, a space in which a vehicle image CG is disposed with respect to a current position P2 of the vehicle 1 in the space in which the camera picture model S is disposed. After generating the virtual space A, the display image generator 401 sets, as a point of gaze P3, a point moved downward from a front end of the vehicle image CG in the virtual space A to the first plane S1 orthogonally thereto, as illustrated in FIG. 6. Then, as illustrated in FIG. 8, the display image generator 401 generates a display image obtained by viewing the point of gaze P3 from a virtual viewpoint P4 received from the operation input unit 10. As a result, the image of the obstacle included in the display image can be viewed simultaneously with the three-dimensional vehicle image CG, so that the positional relation between the vehicle 1 and the obstacle can be easily recognized.

Thereafter, if an instruction is made through the operation input unit 10 to move the virtual viewpoint P4, the display image generator 401 moves the virtual viewpoint P4, and moves the point of gaze P3 in conjunction with the movement of the virtual viewpoint P4. For example, as illustrated in FIG. 9, if the instruction is made to move the virtual viewpoint P4 rightward from a center C of the vehicle image CG in the vehicle width direction of the vehicle image CG, the display image generator 401 moves the virtual viewpoint P4 rightward from the center C of the vehicle image CG in the vehicle width direction of the vehicle image CG, and moves the point of gaze P3 rightward from the center C in the vehicle width direction of the vehicle image CG. Since this operation can move also the point of gaze P3 in a direction toward a point desired to be viewed by the passenger of the vehicle 1 in conjunction with the movement of the virtual viewpoint P4, the display image further facilitating the recognition of the positional relation between the vehicle 1 and the obstacle can be generated without increasing the burden of the user for setting the point of gaze P3.

If the display 8 displays, without any modification, an image in the virtual space A including the camera picture model S to which a captured image obtained by imaging the surrounding area of the vehicle 1 (for example, the area in front of the vehicle 1) in the past position P1 using a wide-angle camera (for example, a camera having an angle of view of 180 degrees) is pasted, an image of the vehicle 1 (for example, an image of a front bumper of the vehicle 1) included in the captured image may be included in the display image, giving the passenger of the vehicle 1 an uncomfortable feeling. In contrast, in the present embodiment, the display image generator 401 can prevent the image of the vehicle 1 included in the captured image from being included in the display image, by providing the camera picture model S at a gap from the past position P1 of the vehicle 1 toward the outside of the vehicle 1. Therefore, the passenger of the vehicle 1 can be prevented from feeling discomfort.

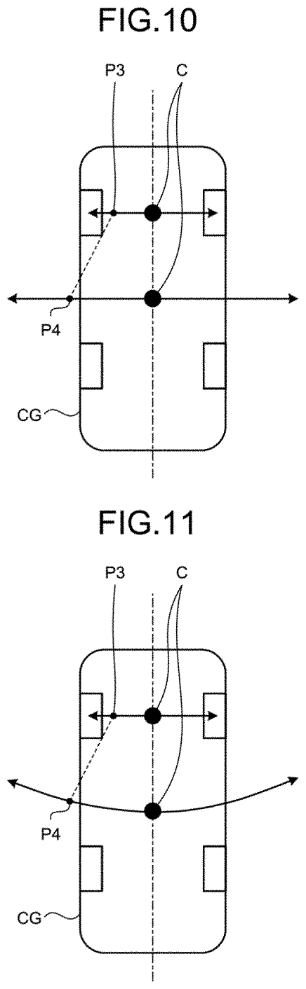

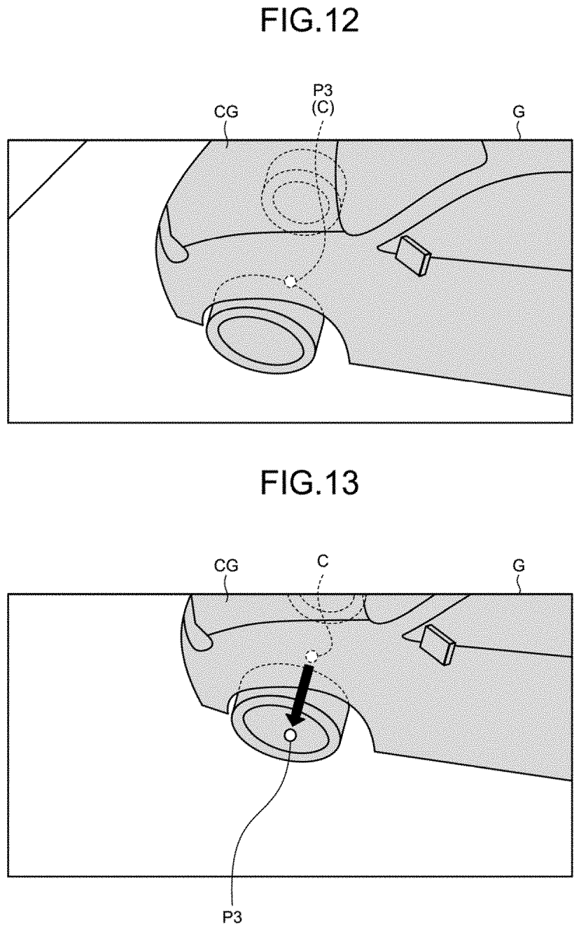

The following describes examples of the movement processing of the point of gaze in the vehicle 1 according to the present embodiment, using FIGS. 10 to 13. FIGS. 10 and 11 are diagrams for explaining the examples of the movement processing of the point of gaze in the vehicle according to the first embodiment. FIG. 12 is a diagram illustrating an example of the display image when the point of gaze is not moved in conjunction with the movement of the virtual viewpoint. FIG. 13 is a diagram illustrating an example of the display image generated in the vehicle according to the first embodiment.

In the present embodiment, if the instruction is made through the operation input unit 10 to move the virtual viewpoint P4 in the vehicle width direction of the vehicle image CG, the display image generator 401 moves the point of gaze P3 in the vehicle width direction of the vehicle image CG in conjunction with the movement of the virtual viewpoint P4 in the vehicle width direction of the vehicle image CG. At that time, the display image generator 401 moves the point of gaze P3 in the same direction as the direction of the movement of the virtual viewpoint P4 in the vehicle width direction of the vehicle image CG. This operation can move the point of gaze P3 closer to a position desired to be checked by the passenger of the vehicle 1 in conjunction with the movement of the virtual viewpoint P4, and therefore, can generate an image desired to be checked by the passenger of the vehicle 1 as the display image.

For example, if the instruction is made to move the virtual viewpoint P4 leftward from the center C of the vehicle image CG in the vehicle width direction of the vehicle image CG, the display image generator 401 moves the point of gaze P3 leftward from the center C of the vehicle image CG in the vehicle width direction of the vehicle image CG in conjunction with the movement of the virtual viewpoint P4 leftward from the center C of the vehicle image CG in the vehicle width direction of the vehicle image CG, as illustrated in FIGS. 10 and 11. The display image generator 401 generates the display image obtained by viewing the point of gaze P3 after being moved from the virtual viewpoint P4 after being moved. At that time, the display image generator 401 generates the display image so as to locate the point of gaze P3 after being moved at the center of the display image.

If, as illustrated in FIG. 12, the point of gaze P3 is not moved in conjunction with the movement of the virtual viewpoint P4, the passenger of the vehicle 1 needs to operate the operation input unit 10 to move the point of gaze P3 located at the center C of the vehicle image CG to a position desired to be viewed (for example, near a wheel of the vehicle image CG) after moving the virtual viewpoint P4. Thus, a display image G desired to be checked by the passenger of the vehicle 1 is difficult to be displayed in a simple way.

In contrast, if, as illustrated in FIG. 13, the point of gaze P3 is moved from the center C of the vehicle image CG in conjunction with the movement of the virtual viewpoint P4, the point of gaze P3 can be moved to the position desired to be viewed by the passenger of the vehicle 1 by simply moving the virtual viewpoint P4. Therefore, the display image G desired to be checked by the passenger of the vehicle 1 can be easily displayed. In the present embodiment, the display image generator 401 moves the point of gaze P3 in the same direction as the direction of the movement of the virtual viewpoint P4 in the vehicle width direction of the vehicle image CG. However, the present invention is not limited to this example. The point of gaze P3 may be moved in a direction opposite to the direction of the movement of the virtual viewpoint P4 in the vehicle width direction of the vehicle image CG.

In the present embodiment, as illustrated in FIGS. 10 and 11, in the case of moving the virtual viewpoint P4, the display image generator 401 sets an amount of movement of the point of gaze P3 in the vehicle width direction of the vehicle image CG smaller than that of the virtual viewpoint P4 in the vehicle width direction of the vehicle image CG. As a result, when the positional relation between the obstacle present near the vehicle 1 and the vehicle 1 is checked, the point of gaze P3 can be prevented from moving by a large amount, so that the obstacle present near the vehicle 1 does not deviate from the view angle of the display image, and the point of gaze P3 can be moved to a position in which the position desired to be viewed by the passenger of the vehicle 1 can be more easily checked.

In the present embodiment, the display image generator 401 sets the amount of movement of the point of gaze P3 in the vehicle width direction of the vehicle image

CG smaller than that of the virtual viewpoint P4 in the vehicle width direction of the vehicle image CG. However, the amount of movement of the point of gaze P3 may be switchable to any one of a plurality of amounts of movement different from one another. As a result, the point of gaze P3 can be moved to a position in the vehicle width direction of the vehicle image CG in which the positional relation with the obstacle desired to be viewed by the passenger of the vehicle 1 can be more easily checked, so that the display image further facilitating the recognition of the positional relation between the vehicle 1 and the obstacle can be displayed.

For example, when displaying the display image in a position where a field of view in the right-left direction of the vehicle 1 is limited, such as at an intersection laterally, with respect to the vehicle 1, confined between, for example, walls, the display image generator 401 sets the amount of movement of the point of gaze P3 in the vehicle width direction of the vehicle image CG larger than that of the virtual viewpoint P4 in the vehicle width direction of the vehicle image CG. As a result, in the position where the field of view in the right-left direction of the vehicle 1 is limited, the point of gaze P3 can be moved over a wide range in the right-left direction of the vehicle 1, so that the display image can be displayed that further facilitates the recognition of the positional relation between the vehicle 1 and the obstacle present in the wide range in the right-left direction of the vehicle 1.

In the present embodiment, the display image generator 401 can also make the position of the point of gaze P3 in the front-rear direction of the vehicle image CG switchable to any one of a plurality of positions different from one another. As a result, the point of gaze P3 can be moved to a position in the front-rear direction of the vehicle image CG in which the positional relation with the obstacle desired to be viewed by the passenger of the vehicle 1 can be more easily checked, so that the display image further facilitating the recognition of the positional relation between the vehicle 1 and the obstacle can be displayed.

For example, if the shift sensor 21 detects that the vehicle 1 travels on the off-road surface based on, for example, the shift of the gear shift operation unit 7 to the low-speed gear position, the display image generator 401 locates the position of the point of gaze P3 in the front-rear direction of the vehicle image CG in the vehicle image CG (for example, in a position of an axle of the vehicle image CG) or near the vehicle image CG. As a result, the display image can be displayed that has a view angle at which the positional relation between the vehicle 1 and the obstacle near the vehicle 1 can be easily recognized. If, in contrast, the shift sensor 21 detects that the vehicle 1 travels on the on-road surface based on, for example, the shift of the gear shift operation unit 7 to the high-speed gear position, the display image generator 401 locates the position of the point of gaze P3 in the front-rear direction of the vehicle image CG in a position separated by a preset distance from the vehicle image CG toward a traveling direction thereof. As a result, the display image can be displayed that facilitates the recognition of the positional relation between the vehicle 1 and the obstacle present in a position separated from the vehicle 1.

In the present embodiment, the display image generator 401 can also move the position of the virtual viewpoint P4 in the front-rear direction of the vehicle image in conjunction with the movement of the virtual viewpoint P4 in the vehicle width direction of the vehicle image CG. For example, if the shift sensor 21 detects that the vehicle 1 travels on the off-road surface based on, for example, the shift of the gear shift operation unit 7 to the low-speed gear position, the display image generator 401 moves the position of the virtual viewpoint P4 in the front-rear direction of the vehicle image CG toward the traveling direction of the vehicle image CG as the position in the vehicle width direction of the virtual viewpoint P4 is displaced from the center C of the vehicle image CG, as illustrated in FIG. 11. As a result, the display image can be generated that has a view angle at which the positional relation between the vehicle 1 and the obstacle present near the vehicle 1 can be easily recognized.

If, in contrast, the shift sensor 21 detects that the vehicle 1 travels on the on-road surface based on, for example, the shift of the gear shift operation unit 7 to the high-speed gear position, the display image generator 401 does not move the position of the virtual viewpoint P4 in the front-rear direction of the vehicle image CG as the position of the virtual viewpoint P4 is displaced from the center C of the vehicle image CG, as illustrated in FIG. 10 (that is, moves the virtual viewpoint P4 parallel to the vehicle width direction of the vehicle image CG). As a result, the display image can be generated that facilitates the recognition of the positional relation between the vehicle 1 and the obstacle present in a position separated from the vehicle 1.

In addition, in the present embodiment, the display image generator 401 can also move the position of the point of gaze P3 in the front-rear direction of the vehicle image CG in conjunction with the movement of the point of gaze P3 in the vehicle width direction of the vehicle image CG. For example, the display image generator 401 moves the position of the point of gaze P3 in the front-rear direction of the vehicle image CG toward the traveling direction of the vehicle image CG as the point of gaze P3 moves away from the center C in the vehicle width direction of the vehicle image CG.

The following describes examples of the display image generated in the vehicle 1 according to the present embodiment, with reference to FIGS. 14 to 16. FIGS. 14 to 16 are diagrams illustrating the examples of the display image generated in the vehicle according to the first embodiment.

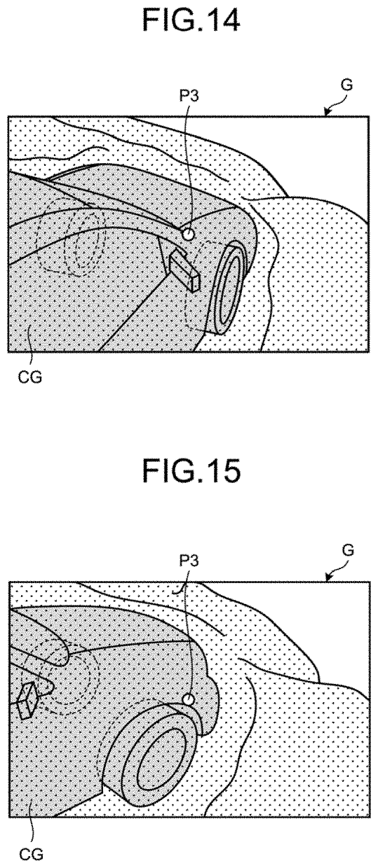

As illustrated in FIG. 14, the display image output unit 402 outputs the display image G generated by the display image generator 401 to the display 8 to display the display image G on the display 8. Thereafter, if the passenger of the vehicle 1 instructs a movement of the virtual viewpoint P4 rightward from the center of the vehicle image CG in the vehicle width direction of the vehicle image CG by, for example, flicking the display screen of the display 8 displaying the display image G illustrated in FIG. 14, the display image generator 401 moves the virtual viewpoint P4 rightward from the center of the vehicle image CG in the vehicle width direction of the vehicle image CG, moves the point of gaze P3 in the same direction as the virtual viewpoint P4, and generates an image obtained by viewing the point of gaze P3 from the virtual viewpoint P4 as the display image G, as illustrated in FIG. 15.

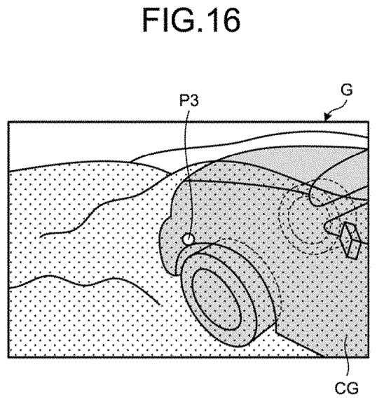

If, instead, the passenger of the vehicle 1 instructs a movement of the virtual viewpoint P4 leftward from the center of the vehicle image CG in the vehicle width direction of the vehicle image CG by flicking the display screen of the display 8, the display image generator 401 moves the virtual viewpoint P4 leftward from the center of the vehicle image CG in the vehicle width direction of the vehicle image CG, moves the point of gaze P3 in the same direction as the virtual viewpoint P4, and generates an image obtained by viewing the point of gaze P3 from the virtual viewpoint P4 as the display image G, as illustrated in FIG. 16. As a result, the display image G can be displayed that is obtained by viewing the positional relation between the vehicle image CG and the obstacle from various angles, so that the positional relation between the vehicle 1 and the obstacle can be more easily recognized.

As described above, since with the vehicle 1 according to the first embodiment, the point of gaze in the direction toward the point desired to be viewed by the passenger of the vehicle 1 can be moved in conjunction with the movement of the virtual viewpoint, the display image facilitating the recognition of the positional relation between the vehicle 1 and the obstacle can be displayed without increasing the burden of the user for setting the point of gaze.

### Second Embodiment

A second embodiment of the present invention is an example of matching the position of the virtual viewpoint with the position of the point of gaze in the vehicle width direction of the vehicle image disposed in the virtual space. In the following description, the same configuration as that of the first embodiment will not be described.

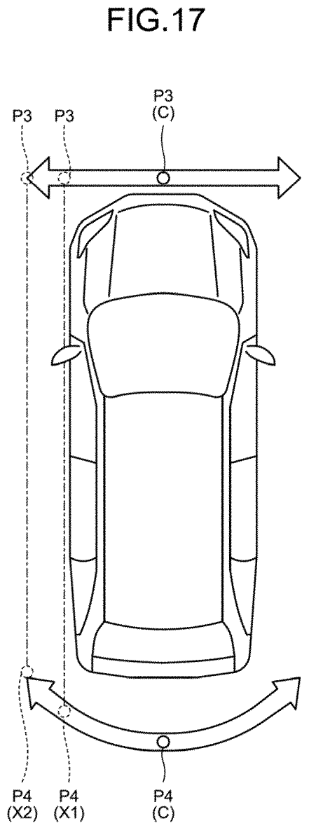

FIG. 17 is a diagram for explaining examples of the movement processing of the point of gaze in the vehicle according to the second embodiment. In the present embodiment, as illustrated in FIG. 17, if an instruction is made through the operation input unit 10 to move the virtual viewpoint P4 to a position X1 on the left side of the center C in the vehicle width direction of the vehicle image CG, the display image generator 401 moves the virtual viewpoint P4 to the position X1. Accordingly, as illustrated in FIG. 17, the display image generator 401 moves the point of gaze P3 leftward from the center C in the vehicle width direction of the vehicle image CG by the same amount of movement as that of the virtual viewpoint P4 in the vehicle width direction of the vehicle image CG.

As illustrated in FIG. 17, if an instruction is made through the operation input unit 10 to move the virtual viewpoint P4 to a position X2 on the left side of the center C in the vehicle width direction of the vehicle image CG, the display image generator 401 moves the virtual viewpoint P4 to the position X2. Accordingly, as illustrated in FIG. 17, the display image generator 401 moves the point of gaze P3 leftward from the center C in the vehicle width direction of the vehicle image CG by the same amount of movement as that of the virtual viewpoint P4 in the vehicle width direction of the vehicle image CG.

In other words, the display image generator 401 matches the position of the virtual viewpoint P4 with the position of the point of gaze P3 in the vehicle width direction of the vehicle image CG disposed in the virtual space A. As a result, as illustrated in FIG. 17, the positional relation between the vehicle image CG and the obstacle present on a lateral side of the vehicle image CG can be easily recognized. Therefore, when the passenger of the vehicle 1 wants to avoid contact of the vehicle 1 with the obstacle present on the lateral side of the vehicle 1 in, for example, a case where the vehicle 1 passes through a narrow passage or approaches a shoulder of a road, the passenger can display the desired display image with a smaller number of operations.

In the present embodiment, if the shift sensor 21 detects that the vehicle 1 travels on the on-road surface based on, for example, the shift of the gear shift operation unit 7 to the high-speed gear position, the display image generator 401 matches the position of the virtual viewpoint P4 with the position of the point of gaze P3 in the vehicle width direction of the vehicle image CG disposed in the virtual space A. If, in contrast, the shift sensor 21 detects that the vehicle 1 travels on the off-road surface based on, for example, the shift of the gear shift operation unit 7 to the low-speed gear position, the display image generator 401 sets the amount of movement of the point of gaze P3 in the vehicle width direction of the vehicle image CG smaller than that of the virtual viewpoint P4 in the vehicle width direction of the vehicle image CG.

As described above, the vehicle 1 according to the second embodiment facilitates the recognition of the positional relation between the vehicle image CG and the obstacle present on the lateral side of the vehicle image CG. Therefore, when the passenger of the vehicle 1 wants to avoid contact of the vehicle 1 with the obstacle present on the lateral side of the vehicle 1 in, for example, the case where the vehicle 1 passes through the narrow passage or approaches the shoulder of the road, the passenger can display the desired display image with the smaller number of operations.

1. A periphery monitoring device comprising:
a processor configured to:
generate a display image obtained by viewing, from a virtual viewpoint, a point of gaze in a virtual space including a model obtained by pasting a captured image obtained by imaging a surrounding area of a vehicle using an imaging unit provided on the vehicle to a three-dimensional plane around the vehicle, and including a three-dimensional vehicle image; and
output the display image to a display, wherein
the processor moves the point of gaze in conjunction with a movement of the virtual viewpoint in a vehicle width direction of the vehicle image when an instruction is made through an operation input unit to move the virtual viewpoint in the vehicle width direction of the vehicle image.

2. The periphery monitoring device according to claim 1, wherein the processor moves the point of gaze in the vehicle width direction.

3. The periphery monitoring device according to claim 2, wherein the processor moves the point of gaze in the same direction as the direction of the movement of the virtual viewpoint in the vehicle width direction.

4. The periphery monitoring device according to claim 1, wherein the processor matches a position of the virtual viewpoint with a position of the point of gaze in the vehicle width direction.

5. The periphery monitoring device according to claim 1, wherein an amount of movement of the point of gaze in the vehicle width direction is switchable to any one of a plurality of amounts of movement different from one another.

6. The periphery monitoring device according to claim 5, wherein the amount of movement of the point of gaze in the vehicle width direction is switchable so as to be smaller than an amount of movement of the virtual viewpoint in the vehicle width direction.

7. The periphery monitoring device according to claim 5, wherein the amount of movement of the point of gaze in the vehicle width direction is switchable so as to be larger than an amount of movement of the virtual viewpoint in the vehicle width direction.

8. The periphery monitoring device according to claim 1, wherein a position of the point of gaze in a front-rear direction of the vehicle image is switchable to any one of a plurality of positions different from one another.
